(19) United States
(12) Patent Application Publication
(10) Pub. No.: US 2013/0285959 A1
(43) Pub. Date: Oct. 31, 2013

(54) ELECTRONIC DEVICE AND CONTROL METHOD FOR ELECTRONIC DEVICE

(71) Applicant: KYOCERA CORPORATION, Kyoto (JP)

(72) Inventor: Yasuhiko NISHIMURA, Yokohama-shi (JP)

(73) Assignee: Kyocera Corporation, Kyoto (JP)

(21) Appl. No.: 13/871,808

(22) Filed: Apr. 26, 2013

(30) Foreign Application Priority Data
Apr. 26, 2012 (JP) 2012-101432

(51) Int. Cl. G06F 3/041

(52) U.S. Cl. CPC G06F 3/0414
USPC 345/173

(57) ABSTRACT

An electronic device (1) is provided with a display unit (20), a contact unit (30) to be touched by a contact object, and a control unit (10) that detects a contact pattern on the contact unit (30) and, based on the contact pattern, alters a number of display pages changed at a time on the display unit (20).

### CROSS REFERENCE TO RELATED APPLICATION

This application claims priority to and the benefit of Japanese Patent Application No. 2012-101432 (filed on Apr. 26, 2012), the entire contents of which are incorporated herein by reference.

### FIELD

Embodiments discussed herein relate to an electronic device and a control method for an electronic device.

### BACKGROUND

In recent years, practical use has been made of electronic devices that transition the page of a browser, electronic book or the like displayed on a display unit based on operations input into a contact detection unit, such as a touch sensor. For example, Patent Literature 1 discloses an electronic device that, when a user contacts a finger to a predetermined location on the screen with a predetermined pressure, performs successive page flips for the duration of the contact while consecutively displaying image information in each updated page on the display unit.

### CITATION LIST

Patent Literature 1: JP2000-163193(A)

### SUMMARY

With the electronic device disclosed in Patent Literature 1, however, pages are flipped one page at a time. As a result, there is a concern that if the desired page is located far forwards or backwards from the currently displayed page, it may take time to transition to the desired page.

In view of the foregoing, an electronic device and a control method for an electronic device that can transition efficiently to a desired page are discussed herein.

An electronic device according to an embodiment comprises: a display unit; a contact unit to be contacted by a contact object; and a control unit configured to detect a contact pattern on the contact unit and, based on the contact pattern, alter a number of display page(s) to be changed at a time on the display unit.

The electronic device according to an aspect of the present embodiment preferably further comprises a pressure detection unit configured to detect pressure on the contact unit, wherein the control unit detects the contact pattern as the pressure detected by the pressure detection unit.

A control method for an electronic device according to another embodiment is a control method for an electronic device provided with a display unit and a contact unit to be touched by a contact object, the control method comprising the steps of: detecting a contact pattern on the contact unit; and altering a number of display page(s) to be changed at a time on the display unit based on the detected contact pattern.

### BRIEF DESCRIPTION OF DRAWINGS

Embodiments will be further described below with reference to the accompanying drawings, wherein:

FIG. 1 is a functional block diagram schematically illustrating the configuration of an electronic device according to an embodiment; and

FIG. 2 is a flowchart schematically illustrating operations of the electronic device in FIG. 1.

### DESCRIPTION OF EMBODIMENTS

According to the embodiment discussed herein, the number of pages changed at a time is altered in accordance with pressure on the contact unit, thereby making it possible to transition efficiently to a desired page.

Embodiments will be described with reference to the accompanying drawings.

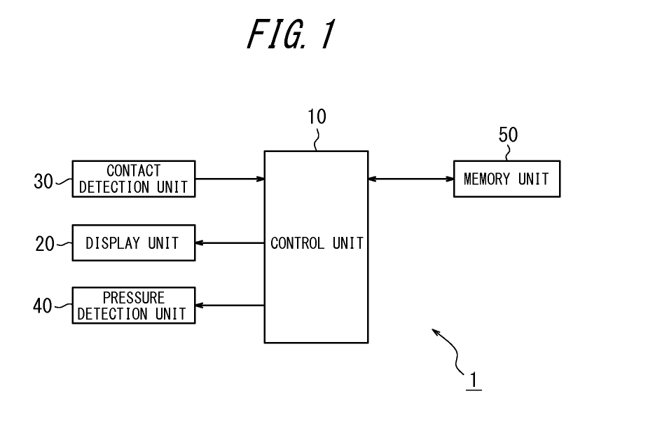

FIG. 1 is a functional block diagram schematically illustrating the configuration of an electronic device according to an embodiment. An electronic device 1 illustrated in FIG. 1 is provided with a control unit 10, a display unit 20, a contact detection unit 30, a pressure detection unit 40 and a memory unit 50.

The control unit 10 controls and manages the entire electronic device 1 by controlling each functional block constituting the electronic device 1. Among processing by the control unit 10, processing of the present embodiment is described below.

The display unit 20 displays images (pages), input objects such as icons and push buttons, and the like for application software (hereinafter simply referred to as an “application”) such as a browser, an electronic book and the like. The display unit 20 may be, for example, constituted by a liquid crystal display panel, an organic EL display panel, electronic paper or the like.

The contact detection unit 30 constitutes a contact unit and is provided on the front face of the display unit 20. When an operator contacts an object displayed on the display unit 20 with a finger, a stylus pen or the like (hereinafter collectively referred to as a “contact object”), the contact detection unit 30 detects the contact on a corresponding touch (contact) face of the contact detection unit 30. The contact detection unit 30 detects the position of the contact by the contact object on the touch face and notifies the control unit 10 of the position of the detected contact. The contact detection unit 30 may, for example, be constituted by a touch sensor that is a resistive film type, a capacitive type, an optical type or the like.

The pressure detection unit 40 detects pressure on the touch face of the contact detection unit 30 and is, for example, constituted by a strain gauge sensor, a piezoelectric element or the like that experiences a change in physical or electrical characteristics (strain, resistance, voltage or the like) in response to pressure. Voltage is an electrical characteristic of a piezoelectric element, and when the pressure detection unit 40 is constituted by a piezoelectric element, for example, the magnitude of the voltage (voltage value, hereinafter simply referred to as “data”) changes in accordance with the magnitude of the load (force) of the pressure on the touch face of the contact detection unit 30 (or the speed at which the magnitude of the load (force) changes (acceleration)).

The control unit 10 acquires data by being notified of the data by the pressure detection unit 40 or by detecting the data of the pressure detection unit 40. Specifically, as the contact pattern of the contact object on the contact detection unit 30, the control unit 10 acquires data based on pressure on the touch face of the contact detection unit 30 from the pressure detection unit 40.

The memory unit 50 may be, for example, constituted by flash memory or the like and stores a variety of information, such as a variety of applications executable by the electronic device 1, a plurality of reference values for the pressure-based data of the pressure detection unit 40 and the number of pages changed at a time for each reference value.

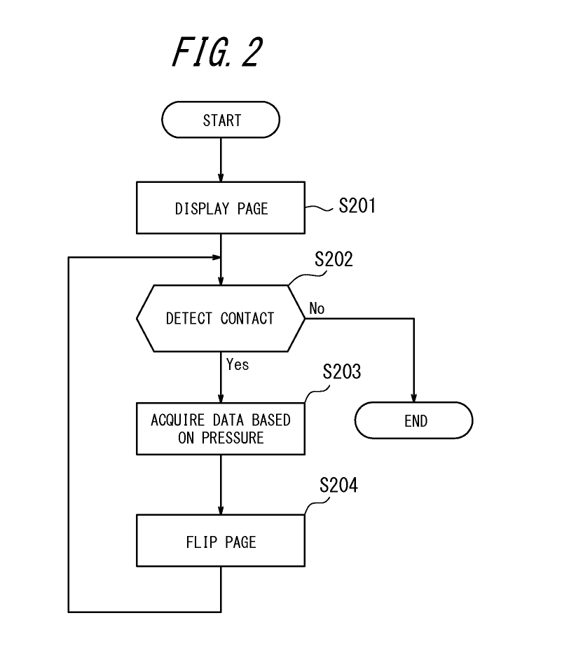

Next, operations of the electronic device 1 according to the present embodiment will be schematically described with reference to the flowchart in FIG. 2.

First, the control unit 10 displays an image (page) for a running application on the display unit 20 (step S201). Next, the control unit 10 monitors for detection by the contact detection unit 30 of contact related to a page flip (step S202). Upon detection of the contact, the control unit 10 acquires data based on pressure on the contact detection unit 30 from the pressure detection unit 40 at, for example, a predetermined timing (step S203) and detects the maximum reference value satisfied by the pressure-based data that was acquired (step S204).

When one of the reference values is detected in step S204, the control unit 10 executes page flip processing in response to the contact input to flip the page forward or backward, using the number of pages changed at a time corresponding to the reference value, and then displays the page that is transitioned to on the display unit 20 (step S205). For example, if the maximum reference value satisfied by the pressure-based data is the smallest reference value, one page is flipped, and if the maximum reference value is the next largest reference value, two pages are flipped. The page that is transitioned to is then displayed on the display unit 20.

As long as the contact related to a page flip is detected by the contact detection unit 30 in step S402, the control unit 10 repeats the processing in steps S203 and S204. When no contact is detected in step S202, i.e. when the contact object such as a finger or the like is released from the contact detection unit 30, the control unit 10 terminates the page flip processing.

With the present embodiment, when the desired page is near the currently displayed page, the user may press the contact detection unit 30 with a relatively weak pressure to perform one-page flips, for example. The user may thus cause the page displayed on the display unit 20 to transition to the desired page.

When the desired page is distant from the currently displayed page, the user can first press the contact detection unit 30 with a relatively strong pressure to perform two-page flips, for example. Subsequently, upon approaching the desired page, the user lessens the pressure to perform to one-page flips. The user can thus efficiently cause the page displayed on the display unit 20 to transition to the desired page.

It is to be understood that the present invention is not limited to the embodiment set forth above, and various changes and modifications may be implemented. For example, in the above embodiment, the contact pattern on the contact detection unit 30 detected by the control unit 10 may be a contact pattern consisting of a sweep amount or vector of the contact object on the contact detection unit 30, or a contact pattern consisting of any combination of pressure, sweep amount, and vector.

The pressure detection unit 40 may be configured in accordance with the type of contact detection of the contact detection unit 30. For example, in the case of resistive film type contact detection, the magnitude of resistance corresponding to the size of the contact area may be detected in association with the load (force) of the pressure on the touch surface of the contact detection unit 30. Alternatively, in the case of capacitive type contact detection, the magnitude of capacitance may be detected in association with the load (force) of the pressure on the touch surface of the contact detection unit 30.

The display unit 20 and the contact detection unit 30 may be constituted by an integrated apparatus, for example by providing a common substrate with both functions. An example of such an apparatus is a liquid crystal panel having a matrix of pixel electrodes, with a plurality of photoelectric conversion elements, such as photodiodes, regularly mixed therein. Such an apparatus is contacted by a pen for contact input at a desired position on the panel display, and while displaying images with the liquid crystal panel structure, the apparatus may detect a contact position by light from a backlight for liquid crystal display being reflected by the tip of the pen and received by surrounding photoelectric conversion elements.

Furthermore, when detecting pressure as the contact pattern, as in the above embodiment, a contact unit that has no contact detection function and is simply contacted by a contact object may be used instead of the contact detection unit 30, such as keys indicating the previous and next page.

### REFERENCE SIGNS LIST

1: Electronic device

10: Control unit

20: Display unit

30: Contact detection unit

40: Pressure detection unit

50: Memory unit

What is claimed is:

1. An electronic device comprising:
a display unit;
a contact unit to be contacted by a contact object; and
a control unit configured to detect a contact pattern on the contact unit and, based on the contact pattern, alter a number of display page(s) to be changed at a time on the display unit.

2. The electronic device of claim 1, further comprising a pressure detection unit configured to detect pressure on the contact unit, wherein
the control unit detects the contact pattern as the pressure detected by the pressure detection unit.

3. A control method for an electronic device provided with a display unit and a contact unit to be touched by a contact object, the control method comprising the steps of:
detecting a contact pattern on the contact unit; and
altering a number of display page(s) to be changed at a time on the display unit based on the detected contact pattern.
